(19) United States
(12) Patent Application Publication
(10) Pub. No.: US 2009/0171030 A1
(43) Pub. Date: Jul. 2, 2009

(54) POLYPROPYLENE-BASED COPOLYMER AND FILM COMPRISING THE POLYPROPYLENE-BASED COPOLYMER

(75) Inventors: Kenji IKEDA, Sodegaura-shi (JP); Shigeki Kishiro, Ichihara-shi (JP); Makoto Satoh, Chiba-shi (JP); Yasuki Fujiwara, Ichikawa-chi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/341,049

(22) Filed: Dec. 22, 2008

(30) Foreign Application Priority Data
Dec. 26, 2007 (JP) P2007-333990
Dec. 26, 2007 (JP) P2007-333994

(51) Int. Cl. B01J 29/04

(52) U.S. Cl. 525/240

(57) ABSTRACT

A polypropylene-based copolymer containing 50 to 95% by weight of a polymer component (component A) mainly comprising the constitutional unit derived from propylene and having a melting point exceeding 155° C. and 5 to 50% by weight of a copolymer component (component B) of propylene, ethylene and an α-olefin having 4 or more carbon atoms in which the content (X) of the constitutional unit derived from propylene is 10≦X<50% by weight, the content (Y) of the constitutional unit derived from ethylene is 50<Y≦70% by weight, the content (Z) of the constitutional unit derived from an α-olefin having 4 or more carbon atoms is 0<Z≦20% by weight (provided that the total of X, Y and Z is 100% by weight), and the weight ratio of the content (Z) of the constitutional unit derived from an α-olefin having 4 or more carbon atoms to the content (X) of the constitutional unit derived from propylene is 1 or less.

### BACKGROUND OF THE INVENTION

1. Field of the Invention

The present invention relates to a polypropylene-based copolymer. More particularly, the present invention relates to a polypropylene-based copolymer suitable as a material of a film for packaging retort foods which is excellent in balance among heat resistance, transparency, sliding properties and low temperature impact resistance, and a film comprising the polypropylene-based copolymer.

2. Related Background Art

Since polypropylene is excellent in rigidity, heat resistance and packaging suitability, it is widely used in the field of packaging materials such as food packaging, fiber packaging and the like. The packaging material is required to have characteristics such as rigidity, heat resistance, low temperature impact resistance, heat sealing properties or blocking resistance or the like, and is further required to have less fish eyes and to be excellent in appearance. Especially for a packaging material for retort foods, there are demanded both heat resistance compatible with retort sterilization in which high temperature processing is performed and impact resistance at low temperature suitable for use at low temperature. In order to maintain the impact resistance at low temperature, it is considered to incorporate a large amount of an elastomer component, but in this case, the compatibility with sliding properties is difficult to achieve.

In addition, since in recent years the packaging material for retort foods has diversified and it is required that contents can be confirmed, as the packaging material for retort foods, there is used a film excellent in transparency so that contents may be confirmed.

In Japanese Patent Application Laid-Open No. 6-93062, there is described that a film obtained from a polypropylene block copolymer having specific properties is good in appearance and is excellent in impact resistance at low temperature, heat resistance, blocking resistance and food hygienic properties. However, with the increase of large-sized retort pouches, a further improvement in impact resistance is demanded.

In Japanese Patent Application Laid-Open No. 8-302093, there is described an impact-resistant polypropylene-based resin composition which is excellent in transparency and comprises 95 to 10 parts by weight of a polypropylene-based resin in which less than 10% by weight of ethylene and/or an α-olefin may be copolymerized and 5 to 90 parts by weight of a copolymer elastomer containing propylene having specific physical properties, ethylene and an α-olefin as the constitutional unit, and a production method thereof. However, when the composition is extrusion processed to produce a film, the resulting film is excellent in transparency but may have insufficient impact resistance at low temperature in some cases.

In Japanese Patent Application Laid-Open No. 58-71910, there is disclosed a method for producing a soft thermoplastic olefin-based block copolymer excellent in heat resistance, impact resistance, surface adhesion and scratch resistance. However, when the composition is used as a film for retort food packaging, it may have insufficient heat resistance in some cases.

In Japanese Patent Application Laid-Open No. 59-115312, there is disclosed a method for producing a copolymer composition for a retort film which is excellent in heat resistance and excellent in impact resistance at low temperature, pinhole resistance, bending resistance and flexibility as well as excellent in stable heat sealing properties and food hygienic properties. However, since this composition is obtained by randomly polymerizing propylene and ethylene and/or an α-olefin having 4 to 12 carbon atoms as the first stage, it is not preferable for use as a film for high retort food packaging in some cases.

### SUMMARY OF THE INVENTION

An object of the present invention is to provide a polypropylene-based copolymer excellent in balance among heat resistance, transparency, sliding properties and low temperature impact resistance, and a film comprising the polypropylene-based copolymer or the polypropylene-based resin composition.

As a result of the earnest studies, the present inventors have found that the present invention can solve the above problems, and completed the present invention.

That is, the present invention relates to a polypropylene-based copolymer comprising 50 to 95% by weight of a polymer component (component A) mainly comprising the constitutional unit derived from propylene and having a melting point exceeding 155° C. and 5 to 50% by weight of a copolymer component (component B) of propylene, ethylene and an α-olefin having 4 or more carbon atoms in which the content (X) of the constitutional unit derived from propylene is 10≦x<50% by weight, the content (Y) of the constitutional unit derived from ethylene is 50<Y≦70% by weight, the content (Z) of the constitutional unit derived from an α-olefin having 4 or more carbon atoms is 0<Z≦20% by weight provided that the total of X, Y and Z is 100% by weight), and the weight ratio of the content (Z) of the constitutional unit derived from an α-olefin having 4 or more carbon atoms to the content (X) of the constitutional unit derived from propylene is 1 or less.

In addition, the present invention relates to a polypropylene-based copolymer comprising a polymer component (component A) mainly comprising a constitutional unit derived from propylene and having a melting point exceeding 155° C. and a copolymer component (component B) of propylene, ethylene and an α-olefin having 4 or more carbon atoms, wherein;

(i) Xylene-Soluble Content at 20° C. (CXS) of the polypropylene-based copolymer is 4-40% by weight, and
(ii) the content (P) of the constitutional unit derived from propylene of the Soluble Content is 30≦P<70% by weight, the content (Q) of the constitutional unit derived from ethylene is 30<Q≦50% by weight, the content (R) of the constitutional unit derived from an α-olefin having 4 or more carbon atoms is 0<R≦20% by weight (provided that the total of P, Q and R is 100% by weight).

### DESCRIPTION OF THE PREFERRED EMBODIMENTS

The polypropylene-based copolymer of the present invention is a polypropylene-based copolymer comprising a polymer component (component A) mainly comprising the constitutional unit derived from propylene and having a melting point exceeding 155° C. and a copolymer component (component B) of propylene, ethylene and an α-olefin having 4 or more carbon atoms.

Xylene-Soluble Content at 20° C. of the polypropylene-based copolymer is 4-40% by weight (% by weight of polypropylene-based copolymer is 100% by weight). The content is preferably 5-35% by weight and more preferably 5-32% by weight. If the Xylene-Soluble Content at 20° C. of the polypropylene-based copolymer is less than 4% by weight, the impact resistance at low temperature may be inferior, and if the content exceeds 40% by weight, the sliding properties may be deteriorated.

With regard to the ratio of the component A and the component B occupying the polypropylene-based copolymer, the content of the component A is 50 to 95% by weight, preferably 60 to 95% by weight, more preferably 60 to 90% by weight, and the content of the component B is 5 to 50% by weight, preferably 5 to 40% by weight, more preferably 10 to 40% by weight. If the content of the component B is less than 5% by weight, the impact resistance at low temperature may be inferior, and if the content of the component B exceeds 50% by weight, the sliding properties may be deteriorated.

The component A is a polymer component mainly comprising the constitutional unit derived from propylene and having a melting point exceeding 155° C. From the viewpoint of heat resistance, the melting point of the component A is preferably higher than 158° C. and more preferably 160° C. or higher. In addition, the component A may be produced by copolymerizing ethylene with an α-olefin such as 1-butene and the like in a range so that the melting point is not 155° C. or lower, but preferably is a propylene homopolymer. When ethylene is copolymerized with an α-olefin such as 1-butene and the like, the content of the constitutional unit derived from an α-olefin in the polymer component (component A) mainly comprising the constitutional unit derived from propylene is 5% by weight or less and preferably 3% by weight or less (provided that the polymer component mainly comprising the constitutional unit derived from propylene is 100% by weight). The intrinsic viscosity of the component A is not particularly limited, but is in the range of preferably 1.5 to 3.0 dL/g and more preferably 1.5 to 2.5 dL/g.

The content (Y) of the constitutional unit derived from ethylene contained in the component B is 50<Y≦70% by weight, preferably 52≦Y≦˜70% by weight and more preferably 55≦y≦70% by weight (provided that the total of the content (X) of the constitutional unit derived from propylene contained in the component B, the content (Y) of the constitutional unit derived from ethylene and the content (Z) of the constitutional unit derived from an α-olefin having 4 or more carbon atoms is 100% by weight). If the content (Y) of the constitutional unit derived from ethylene is 50% by weight or less, the impact resistance may be decreased, and if the content (Y) of the constitutional unit derived from ethylene exceeds 70% by weight, the transparency may be decreased.

The content (Z) of the constitutional unit derived from an α-olefin contained in the component B is 0<Z≦0% by weight, preferably 1≦E≦16% by weight and more preferably 1≦z≦10% by weight (provided that the total of the content (X) of the constitutional unit derived from propylene contained in the component B, the content (Y) of the constitutional unit derived from ethylene and the content (Z) of the constitutional unit derived from an α-olefin having 4 or more carbon atoms is 100% by weight). If the content (Z) of the constitutional unit derived from an α-olefin is 0% by weight, the transparency may be decreased, and if the content (Z) of the constitutional unit derived from an α-olefin exceeds 20% by weight, the impact resistance at low temperature may be decreased.

The weight ratio of the content (Z) of the constitutional unit derived from an α-olefin having 4 or more carbon atoms to the content (X) of the constitutional unit derived from propylene in the component B is 1 or less, preferably 0.7 or less, and more preferably 0.5 or less. If the weight ratio of the content (Z) of the constitutional unit derived from an α-olefin having 4 or more carbon atoms to the content (X) of the constitutional unit derived from propylene is set at 1 or less, the impact resistance at low temperature is increased.

As the constitutional unit derived from an α-olefin having 4 or more carbon atoms contained in the component B, there may be mentioned the constitutional unit derived from 1-butene, 1-pentene, 1-hexene, 1-heptene, 1-octene, 4-methyl-1-pentene, vinylcyclohexane, vinylnorbornene and the like, and preferred is 1-butene. The intrinsic viscosity of the component B is not particularly limited, but is in the range of preferably 2.0 to 5.0 dL/g and more preferably 2.5 to 4.5 dL/g.

The content (Q) of the constitutional unit derived from ethylene contained in Xylene-Soluble Content at 20° C. of the polypropylene-based copolymer is 30<Q≦50% by weight, preferably 32≦Q≦50% by weight, and more preferably 35≦Q≦50% by weight (provided that the total of P, Q and R is 100% by weight). If the content (Q) of the constitutional unit derived from ethylene is 30% by weight or less, the impact resistance may be decreased, and if the content exceeds 50% by weight, the transparency may be decreased.

The content (R) of the constitutional unit derived from an α-olefin having 4 or more carbon atoms contained in Xylene-Soluble Content at 20° C. of the polypropylene-based copolymer is 0<R≦20% by weight, preferably 1≦R≦16% by weight, and more preferably 1≦R≦10% by weight (provided that the total of P, Q and R is 100% by weight). If the content (R) of the constitutional unit derived from an α-olefin having 4 or more carbon atoms is 0% by weight, the transparency may be decreased, and if the content (R) of the constitutional unit derived from an α-olefin having 4 or more carbon atoms exceeds 20% by weight, the impact resistance at low temperature may be decreased.

There is no particular limit to an intrinsic viscosity of the polypropylene-based copolymer, but the range of 1.6-4.0 dL/g is preferable, and the range of 2.0-3.6 dL/g is more preferable.

As a method for producing a polypropylene-based copolymer of the present invention, there may be mentioned a method for producing the polypropylene-based copolymer by polymerizing the polymer component (component A) mainly comprising the constitutional unit derived from propylene and continuously polymerizing the copolymer component (component B) of propylene, ethylene and an α-olefin having 4 or more carbon atoms. The polypropylene-based copolymer may be produced using a typical stereoregular catalyst by various polymerization methods.

The stereoregular catalyst includes, for example, a catalyst comprising a solid titanium catalyst component, an organic metal compound catalyst component and an electron donor used as needed, a catalyst system comprising a transition metal compound of group IVB of the Periodic Table having a cyclopentadienyl ring and an alkylaluminoxane, or a catalyst comprising a transition metal compound of group IVB of the Periodic Table having a cyclopentadienyl ring, a compound forming an ionic complex by reacting with the transition metal compound and an organoaluminum compound. Among these, preferred is a production method of using a catalyst comprising a solid titanium catalyst component, an organometal compound catalyst component and an electron donor further used as needed.

The solid titanium catalyst component includes, for example, a trivalent titanium compound-containing solid catalyst component which is obtained by bringing a solid catalyst component precursor obtained by reducing a titanium compound with an organomagnesium compound into contact with a halogen compound (for example, titanium tetrachloride) and an electron donor (for example, an ether compound and a mixture of an ether compound and an ester compound) in the presence of a silicon compound.

The organometal compound catalyst component includes an organoaluminum compound having at least one Al-carbon bond in the molecule, and preferable are a trialkylaluminum, a mixture of a trialkylaluminum and a dialkylaluminum halide or an alkylalumoxane, and especially preferable are triethylaluminum, triisobutylaluminum, a mixture of triethylaluminum and diethylaluminum chloride or tetraethyldialumoxane.

The electron donor compound includes an oxygen-containing compound, a nitrogen-containing compound, a phosphorus-containing compound and a sulfur-containing compound. Among these, preferred is an oxygen-containing compound or a nitrogen-containing compound, more preferred is an oxygen-containing compound and especially preferred are alkoxysilicons or ethers.

Specifically, there may be mentioned, for example, a catalyst system comprising (a) a trivalent titanium-containing solid catalyst component obtained by treating, in coexistence of a silicon compound having a Si—O bond, a solid product, which is obtained by reducing a titanium compound represented by the general formula Ti(OR₁)ₙX₄₋ₙ(R₁ represents a hydrocarbon group having 1 to 20 carbon atoms, X represents a halogen electron atom and n represents a number of 0<n≦4) with an organomagnesium compound, with a mixture of an ester compound, an ether compound and titanium tetrachloride, (b) an organoaluminum compound and (c) a silicon compound having a Si—OR₂ bond (R₂ is a hydrocarbon group having 1 to 20 carbon atoms).

Further, the organoaluminum compounds are used so that the molar ratio of the Al atom in the (b) component to the Ti atom in the (a) component is 1 to 200, preferably 5 to 1500, and the molar ratio of the (C) component to the Al atom in the (b) component is 0.02 to 500 and preferably 0.05 to 50.

Hereinafter, the polymerization method is explained. The polymerization method for producing a polypropylene-based copolymer of the present invention is preferably a continuous polymerization method. The continuous polymerization method, for example, may be either a batch system (wherein materials are added to one reaction tank and reaction occurs continuously) or a continuous system (wherein plural reaction tanks are connected and reaction occurs in each reaction tanks one by one. In addition, the polymerization method usable in the present invention includes a slurry polymerization or a solution polymerization using an inert hydrocarbon solvent such as propane, butane, isobutane, pentane, hexane, heptane, octane or the like, a bulk polymerization or a vapor phase polymerization in which a liquid olefin at the polymerization temperature is used as a medium, and a bulk-vapor phase polymerization which performs those continuously and the like, preferable method is a vapor phase polymerization. The polymerization may be performed at the polymerization temperature of usually −30 to 300° C. and preferably 20 to 180° C. The polymerization pressure is not particularly limited, but from an industrial and economical viewpoint, it is generally from atmospheric pressure to 10 MPa and preferably approximately 200 kPa to 5 MPa. The second process described later is especially preferably a vapor phase polymerization. In order to adjust the molecular weight of a polymer, there may be also added a chain transfer agent such as hydrogen and the like at the time of polymerization.

The polypropylene-based copolymer of the present invention is produced by the following processes using the above-mentioned catalysts and polymerization methods.

Polymerization Process 1: A process of homopolymerizing propylene to produce a polypropylene homopolymer component (component A) or a process of copolymerizing propylene, ethylene and at least one kind of olefin selected from the group consisting of an α-olefin having 4 to 10 carbon atoms to produce a polymer component (component A) mainly comprising the constitutional unit derived from propylene.

Polymerization Process 2: A process of producing a copolymer component (component B) from an ethylene-based copolymer component produced by copolymerizing propylene, ethylene and an α-olefin having 4 or more carbon atoms in the presence of the polypropylene homopolymer component obtained in the above step 1 or a copolymer component mainly comprising the constitutional unit derived from propylene.

The ratio of the component A to the component B may be changed by changing the time for polymerizing the polymer component (component A) mainly comprising the constitutional unit derived from propylene and the time for polymerizing the copolymer component (component B) of propylene, ethylene and an α-olefin having 4 or more carbon atoms. In addition, the composition of the component B may be changed by changing the gas composition in a mixed gas of propylene, ethylene and an α-olefin when polymerizing the copolymer component (component B) of propylene, ethylene and an α-olefin having 4 or more carbon atoms.

A polypropylene-based copolymer of the present invention is preferably produced by the continuous polymerization method. On the other hand, unless the object of the present invention is not obstructed, polypropylene-based resin composition may be produced by adding other polymer such as a propylene homopolymer or an ethylene-α-olefin copolymer and the like other than the polypropylene-based copolymer to the polypropylene-based copolymer produced as mentioned above. Here, a polypropylene-based resin composition is prepared so that from the viewpoint of the balance between sliding properties and low temperature impact resistance, the content of the copolymer component (component B) of propylene, ethylene and an α-olefin having 4 or more carbon atoms is preferably 5% by weight or more and less than 30% by weight and more preferably 10% by weight or more and less than 30% by weight based on the whole polypropylene-based resin composition. The propylene homopolymer added preferably fulfill the requirements of component (A), that is, the propylene homopolymer preferably has melting point of more than 155° C.

To the polypropylene-based copolymer and the polypropylene-based resin composition of the present invention, there may be added a neutralizer, an antioxidant, an ultraviolet absorber, an antistatic agent, an antifogging agent, a sliding agent, an antiblocking agent, a nucleating agent, an organic peroxide and the like, when needed.

The polypropylene-based copolymer and the polypropylene-based resin composition of the present invention may be molded by a method usually industrially used to produce a molded product. For example, there may be mentioned an extrusion molding method, a blow molding method, an injection molding method, a compression molding method, a calendar molding method and the like.

The polypropylene-based copolymer and the polypropylene-based resin composition of the present invention are preferably used for a film application by an extrusion molding method such as a T-die molding method, a tubular molding method and the like. Especially preferred is an unstretched film formed by a T-die method. The film has a thickness of preferably 10 to 500 μm and more preferably 10 to 100 μm. The film may be subjected to surface treatment by a method usually industrially employed such as corona discharge treatment, flame treatment, plasma treatment, ozone treatment and the like.

The polypropylene-based copolymer and the polypropylene-based resin composition of the present invention are preferably used as a film for retort food packaging which is subjected to heat treatment at high temperature. In addition, the film is also suitably used as one layer of a composite film. The composite film comprises a film of the present invention and other film, including, for example, a polypropylene biaxially stretched film, an unstretched nylon film, a stretched polyethyl terephthalate film, an aluminum foil and the like. The production method of the composite film includes a dry lamination method and an extrusion lamination method.

### EXAMPLES

Hereinafter, the present invention is explained using Examples and Comparative Examples but the scope of the present invention is not limited by these Examples. In addition, the measurement value in each item in the detailed descriptions, Examples and Comparative Examples of the present invention was measured by the following methods.

(1) Melting Point (Unit: ° C.)

After melting 10 mg of a test piece at 200° C. under a nitrogen gas atmosphere using a differential scanning calorimeter (DSC Q100, manufactured by TA Instrument Co., Ltd.), the temperature was maintained at 200° C. for 5 minutes and then was decreased to −90° C. at a temperature-decreasing rate of 10° C./min. Thereafter, the temperature was increased at a temperature-raising rate of 10° C./min, and the temperature of the maximum peak of the melting endothermic curve obtained was defined as the melting point (Tm).

(2) MFR (Unit: g/10 min)

The MFR was measured at 230° C. under a load of 2.16 kgf according to JIS K7210.

(3) Intrinsic Viscosity ([η], Unit: dL/g)

The intrinsic viscosity was measured in tetralin at 135° C. using an Ubbellohde type viscometer.

(4) Intrinsic Viscosity of Component A [η]A ([η], Unit: dL/g)

The intrinsic viscosity [η] A of the polymer portion (component A) of the monomers mainly comprising propylene was measured by the method mentioned above (2) by taking out the polymer powder from the polymerization tank after completion of the polymerization of component A.

(5) Intrinsic Viscosity of Component B [η]B ([η], Unit: dL/g)

By measuring the intrinsic viscosity [η]A of the polymer component (component A) of the monomers mainly comprising propylene and the intrinsic viscosity [η]T of the whole polypropylene-based copolymer containing the component A and the component B by the method mentioned above (3) and using the polymerization ratio χ of the component B to the whole polypropylene-based copolymer, the intrinsic viscosity [η]B of the copolymer component (component B) of propylene, ethylene and an α-olefin having 4 or more carbon atoms was determined by calculation from the following equation (the polymerization ratio χ of the component B to the whole polypropylene-based copolymer was determined by the method described in the following (6)).

[η]B=[η]T/χ−(1/χ−1)[η]A

[η]A: The intrinsic viscosity of polymer portion of the monomers mainly comprising propylene (dL/g)

[η]T: The intrinsic viscosity of the whole polypropylene-based copolymer containing the component A and the component B (dL/g)

χ: The polymerization ratio of the component B to the whole polypropylene-based copolymer

(6) Polymerization Ratio of Component B to Whole Polypropylene-Based Copolymer: χ (Unit: % by Weight)

In Examples 1-9 and Comparative Examples 1-4, the polymerization ratio χ of the copolymer component (component B) of propylene, ethylene and an α-olefin having 4 or more carbon atoms to the whole polypropylene-based copolymer containing the component A and the component B was calculated from the following method.

χ=1−Mg(T)/Mg(P)

Mg(P): The magnesium content of the polymer taken out from the polymerization tank after completion of the polymerization of the polymer portion (component A) of the monomers mainly comprising propylene

Mg(T): The magnesium content of the whole polypropylene-based copolymer containing the component A and the component B

A sample was added to a sulfuric acid aqueous solution (1 mol/L) and followed by irradiation of ultrasonic waves to extract a metal component. For the resulting liquid portion, the magnesium content of the polymer was quantitatively measured by IPC optical emission spectrometry.

The following formula was used for the calculation in Example 10.

χ=1−ΔH_{B}/ΔH_{A}

ΔH_{A}: The heat of fusion (J/g) of a polymer after the polymerization of a polymer component (component A) mainly comprising the constitutional unit derived from propylene.
ΔH_{B}: The heat of fusion (J/g) of a polymer after the polymerization of a copolymer component (component B) of propylene, ethylene and an α-olefin having 4 or more carbon atoms.

(7) Content of Constitutional Unit Derived from Ethylene or 1-Butene in Component B (Unit: % by Weight)

In Examples 1-9 and Comparative Examples 1-4, the content (C2′ (T)) of the constitutional unit derived from ethylene in the polypropylene-based copolymer containing the component A and the component B and the content (C4′ (T)) of the constitutional unit derived from 1-butene were determined based on the description of J of Polymer Science; Part A; Polymer Chemistry, 28, 1237-1254, 1990.

In Example 10, the content (C2′(T)) of the constitutional unit derived from ethylene in a polypropylene-based copolymer comprising component A and component B and the content (C4′ (T)) of the constitutional unit derived from 1-butene were determined by the method described in pages 616-619 of polymer handbook (1995, published by Kinokuniya Shoten).

Next, the content (Y) and the content (Z) of the constitutional unit derived from ethylene or 1-butene of the component B were calculated from C2′ (T), C4′ (T) and χ described in the above (5) by the following method.

Y=C2′(T)/χ×100

Z=C4′(T)/χ×100

(8) Xylene-Soluble Content at 20° C. of Component A (CXS, Unit: % by Weight)

The polymer powder was taken out from the polymerization tank after completion of the polymerization of the component A portion and the xylene soluble content in at 20° C. was expressed in percentage (% by weight).

(9) Xylene-Soluble Content at 20° C. (CXS(T), Unit: % by Weight) in a Polypropylene-Based Copolymer Comprising Component A and Component B

200 mL of Xylene was added to 1 g of polypropylene-based copolymer, which was boiled until completely dissolved and then cooled, and condition was regulated at 20° C. for more than one hour. Then, filter paper was used to separate into solubles and insolubles. The content of solubles were determined by measuring a weight of a sample obtained by eliminating the solvent in the filtrate and drying the residue.

(10) The Content (Q or R, Unit: % by Weight) of the Constitutional Unit Derived from Ethylene or 1-Butene in a Xylene-Soluble Content at 20° C. in a Polypropylene-Based Copolymer Comprising Component A and Component B

Xylene-Soluble Content at 20° C. which was separated by the method indicated in (9) above was determined based on the disclosures in J of Polymer1 Science; Part A; Polymer Chemistry, 28, 1237-1254, 1990.

(11) Transparency (Haze, Unit: %)

The transparency was measured according to JIS K7105.

(12) Static Friction Coefficient (Unit: μs) and Dynamic Friction Coefficient (Unit: μk)

By overlapping the measurement surfaces of two pieces of a film sample of MD 100 mm×50 mm under room temperature at 23° C. and humidity of 50% and using a weight of 79.4 g at the setting area of 40 mm×40 mm, the static friction coefficient and the dynamic friction coefficient were measured at a moving rate of 15 cm/min by a friction meter TR-2 Model (manufactured by Toyo Seiki Seisaku-sho, Ltd.).

(13) Impact Resistance (Unit: kJ/m)

After placing a film in a constant-temperature chamber set at a predetermined temperature (−15° C.), the impact strength of the film was measured using a hemispherical impact head having a diameter of 15 mm by a film impact tester manufactured by Toyo Seiki Seisaku-sho, LTD.

### Example 1

### (1) Production of Polypropylene-Based Copolymer (BCPP1)

### Polymerization of Component A

An autoclave made of stainless steel and equipped with a stirrer having an inner volume of 3 liters was dried under reduced pressure, purged with argon, cooled and then vacuumized. In heptane contained in a glass charger, 4.4 mmol of triethylaluminum as the (b) component, 0.44 mmol of tert-butyl-n-propyldimethoxysilane as the (c) component and 11.7 mg of the solid catalyst component described in Japanese Patent Laid-Open No. 2004-182981, Example 1 (2) as the (a) component were brought into contact and thereafter they were added together to the autoclave, and further 780 g of liquefied propylene was charged. Subsequently, hydrogen was charged until the pressure inside the autoclave was increased by 0.15 MPa and then the autoclave was heated to 80° C. to start polymerization. After 10 minutes from the start of the polymerization, unreacted propylene was purged outside the polymerization system. After the inside of the autoclave was replaced with argon, a small amount of a polymer was sampled. The polymer sampled had a melting point (Tm) of 163.8° C., an intrinsic viscosity ([η]P) of 1.77 dL/g and a xylene-soluble content (CXS) at 20° C. of 0.6% by weight.

### (2) Production of Polypropylene-Based Copolymer (BCPP1)

### Polymerization of Component B

Subsequently, the 3-L autoclave was depressurized and a steel cylinder having an inner volume of 24 liters connected to the 3-L autoclave was vacuumized. A mixed gas was prepared by adding 210 g of propylene, 190 g of ethylene and 80 g of 1-butene and then heating to 80° C. The mixed gas was continuously fed to the 3-L autoclave and the polymerization pressure was set at 0.8 MPa and the polymerization temperature was set at 70° C. to perform polymerization for 1.2 hours. After 1.2 hours, the gas in the autoclave was purged to terminate the polymerization and the resulting polymer was dried under reduced pressure at 60° C. for 5 hours to obtain 260 g of a polymerized powder. The resulting polymer had an intrinsic viscosity ([η]T) of 2.68 dL/g. As a result of the analysis, the content of a ethylene-propylene-butene copolymer portion (hereinafter, referred to as EPB portion) was 37% by weight. Therefore, the polymer produced in the latter stage (the EPB portion) had an intrinsic viscosity ([η] EPB) of 4.24 dL/g. In addition, the ethylene content in the EPB portion was 59% by weight, and the 1-butene content in the EPB portion was 8% by weight. The polymerization conditions are shown in Table 1 and the analytical results of the resulting polymer are shown in Table 2.

### (3) Production of Film and its Physical Properties

To 194.4 g of a polypropylene-based copolymer (BCPP1) and 255.6 g of a propylene homopolymer having a [η] of 1.57 and a Tm of 162.1° C. were added 0.05 parts by weight of calcium stearate, 0.20 parts by weight of Irganox 1010 produced by Ciba Specialty Chemicals) and 0.05 parts by weight of Irgafos 168 (produced by Ciba Specialty Chemicals) as a stabilizer, followed by melt-kneading the mixture at 250° C. using a single screw extruder having a diameter of 20 mm (VS20-14 Type, equipped with a full-flight type screw, manufactured by Tanabe Plastics Machinery Co, Ltd., L/D=12.6) to obtain a polypropylene-based resin composition having an MFR of 4.1 (g/10 min).

The resulting polypropylene-based resin composition was melt-extruded at a resin temperature of 280° C. using a T-die film forming machine having a diameter of 20 mm (VS20-14 Type, equipped with a T-die having a width of 100 mm, manufactured by Tanabe Plastics Machinery Co, Ltd.). The melt-extruded product was cooled with a cooling roll in which cooling water at 30° C. is passed, thereby obtaining a film having a thickness of 30 μm. The physical properties of the resulting film are shown in Table 4.

### Example 2

### (1) Production of Polypropylene-Based Copolymer (BCPP2)

Polymerization was carried out in the same manner as in Example 1 except for using 13.0 mg of the (a) component, using a gas prepared by adding 240 g of propylene, 190 g of ethylene and 40 g of 1-butene as a mixed gas in the polymerization of the component B, and changing the polymerization time to 1.0 hour. The polymerization conditions are shown in Table 1 and the analytical results of the resulting polymer are shown in Table 2.

### (2) Production of Film and its Physical Properties

Except that 250.2 g of BCPP2 was used as a polypropylene-based copolymer and 199.8 g of a propylene homopolymer having a [η] of 1.57 and a Tm of 163.5° C. was added, a polypropylene-based resin composition having an MFR of 3.8 (g/10 min) was obtained in the same manner as in Example 1.

The resulting polypropylene-based resin composition was extrusion processed in the same manner as in Example 1, thereby obtaining a film. The physical properties of the resulting film are shown in Table 4.

### Example 3

### (1) Production of Polypropylene-Based Copolymer (BCPP3)

Polymerization was carried out in the same manner as in Example 1 except for using 9.4 mg of the (a) component, using a gas prepared by adding 200 g of propylene, 170 g of ethylene and 150 g of 1-butene as a mixed gas in the polymerization of the component B, and changing the polymerization time to 1.0 hour. The polymerization conditions are shown in Table 1 and the analytical results of the resulting polymer are shown in Table 2.

### (2) Production of Film and its Physical Properties

Except that 128.7 g of BCPP3 was used as a polypropylene-based copolymer and 171.3 g of a propylene homopolymer having a [α] of 1.57 and a Tm of 163.5° C. was added, a polypropylene-based resin composition having an MFR of 3.8 (g/10 min) was obtained in the same manner as in Example 1.

The resulting polypropylene-based resin composition was extrusion processed in the same manner as in Example 1, thereby obtaining a film. The physical properties of the resulting film are shown in Table 4.

### Example 4

### (1) Production of Polypropylene-Based Copolymer (BCPP4)

Polymerization was carried out in the same manner as in Example 1 except for using 11.1 mg of the (a) component, using a gas prepared by adding 250 g of propylene, 190 g of ethylene and 30 g of 1-butene as a mixed gas in the polymerization of the component B, and changing the polymerization time to 1.1 hours. The polymerization conditions are shown in Table 1 and the analytical results of the resulting polymer are shown in Table 2.

### (2) Production of Film and its Physical Properties

Except that 222.4 g of BCPP4 was used as a polypropylene-based copolymer and 177.6 g of a propylene homopolymer having a [η] of 1.57 and a Tm of 163.5° C. was added, a polypropylene-based resin composition having an MFR of 3.8 (g/10 min) was obtained in the same manner as in Example 1.

The resulting polypropylene-based resin composition was extrusion processed in the same manner as in Example 1, thereby obtaining a film. The physical properties of the resulting film are shown in Table 4.

### Example 5

### (1) Production of Polypropylene-Based Copolymer (BCPP5)

Polymerization was carried out in the same manner as in Example 1 except for using 9.2 mg of the (a) component, using a gas prepared by adding 260 g of propylene, 190 g of ethylene and 20 g of 1-butene as a mixed gas in the polymerization of the component B, and changing the polymerization time to 0.9 hour. The polymerization conditions are shown in Table 1 and the analytical results of the resulting polymer are shown in Table 2.

### (2) Production of Film and its Physical Properties

Except that 231.6 g of BCPP5 was used as a polypropylene-based copolymer and 168.4 g of a propylene homopolymer having a [η] of 1.57 and a Tm of 163.5° C. was added, a polypropylene-based resin composition having an MFR of 4.6 (g/10 min) was obtained in the same manner as in Example 1.

The resulting polypropylene-based resin composition was extrusion processed in the same manner as in Example 1, thereby obtaining a film. The physical properties of the resulting film are shown in Table 4.

### Example 6

### (1) Production of Polypropylene-Based Copolymer (BCPP6)

Polymerization was carried out in the same manner as in Example 1 except for using 11.1 mg of the (a) component, using a gas prepared by adding 170 g of propylene, 220 g of ethylene and 80 g of 1-butene as a mixed gas in the polymerization of the component B, and changing the polymerization time to 0.7 hour. The polymerization conditions are shown in Table 1 and the analytical results of the resulting polymer are shown in Table 2.

### (2) Production of Film and its Physical Properties

Except that 238.5 g of BCPP6 was used as a polypropylene-based copolymer and 211.5 g of a propylene homopolymer having a [η] of 1.57 and a Tm of 163.5° C. was added, a polypropylene-based resin composition having an MFR of 3.5 (g/10 min) was obtained in the same manner as in Example 1.

The resulting polypropylene-based resin composition was extrusion processed in the same manner as in Example 1, thereby obtaining a film. The physical properties of the resulting film are shown in Table 4.

### Comparative Example 1

### (1) Production of Polypropylene-Based Copolymer (BCPP7)

Polymerization was carried out in the same manner as in Example 1 except for using 8.8 mg of the (a) component, using a gas prepared by adding 340 g of propylene and 140 g of ethylene as a mixed gas in the polymerization of the component B, and changing the polymerization time to 0.7 hour. The polymerization conditions are shown in Table 1 and the analytical results of the resulting polymer are shown in Table 2.

### (2) Production of Film and its Physical Properties

Except that 132.3 g of BCPP6 was used as a polypropylene-based copolymer and 167.7 g of a propylene homopolymer having a [η] of 1.57 and a Tm of 163.5° C. was added, a polypropylene-based resin composition having an MFR of 4.2 (g/10 min) was obtained in the same manner as in Example 1.

The resulting polypropylene-based resin composition was extrusion processed in the same manner as in Example 1, thereby obtaining a film. The physical properties of the resulting film are shown in Table 4.

### Comparative Example 2

### (1) Production of Polypropylene-Based Copolymer (BCPP8)

Polymerization was carried out in the same manner as in Example 1 except for using 10.9 mg of the (a) component, using a gas prepared by adding 260 g of propylene, 110 g of ethylene and 170 g of 1-butene as a mixed gas in the polymerization of the component B, and changing the polymerization time to 2.0 hours. The polymerization conditions are shown in Table 1 and the analytical results of the resulting polymer are shown in Table 2.

### (2) Production of Film and its Physical Properties

Except that 231.8 g of BCPP7 was used as a polypropylene-based copolymer and 218.2 g of a propylene homopolymer having a [η] of 1.57 and a Tm of 163.5° C. was added, a polypropylene-based resin composition having an MFR of 4.4 (g/10 min) was obtained in the same manner as in Example 1.

The resulting polypropylene-based resin composition was extrusion processed in the same manner as in Example 1, thereby obtaining a film. The physical properties of the resulting film are shown in Table 4.

### Comparative Example 3

### (1) Production of Polypropylene-Based Copolymer (BCPP9)

Polymerization was carried out in the same manner as in Example 1 except for using 12.0 mg of the (a) component, using a gas prepared by adding 160 g of propylene, 150 g of ethylene and 230 g of 1-butene as a mixed gas in the polymerization of the component B, and changing the polymerization time to 1.2 hour. The polymerization conditions are shown in Table 1 and the analytical results of the resulting polymer are shown in Table 2.

### (2) Production of Film and its Physical Properties

Except that 225 g of BCPP9 was used as a polypropylene-based copolymer and 225 g of a propylene homopolymer having a [η] of 1.57 and a Tm of 163.5° C. was added, a polypropylene-based resin composition having an MER of 4.0 (g/10 min) in the same manner as in Example 1.

The resulting polypropylene-based resin composition was extrusion processed in the same manner as in Example 1, thereby obtaining a film. The physical properties of the resulting film are shown in Table 4.

### Example 7

### (1) Production of Polypropylene-Based Copolymer (BCPP10)

### Polymerization of Component A

An autoclave made of stainless steel and equipped with a stirrer having an inner volume of 3 liters was dried under reduced pressure, purged with argon, cooled and then vacuumized. In heptane contained in a glass charger, 4.4 mmol of triethylaluminum as the (b) component, 0.44 mmol of tert-butyl-n-propyldimethoxysilane as the (c) component and 12.9 mg of the solid catalyst component described in Japanese Patent Laid-Open No. 2004-182981, Example 1 (2) as the (a) component were brought into contact and thereafter they were added together to the autoclave, and further 780 g of liquefied propylene was charged. Subsequently, 4 g of ethylene was charged and hydrogen was charged until the pressure inside the autoclave was increased by 0.15 MPa and then the autoclave was heated to 80° C. to start polymerization. After 10 minutes from the start of the polymerization, unreacted propylene was purged outside the polymerization system. After the inside of the autoclave was replaced with argon, a small amount of a polymer was sampled. The polymer sampled had a melting point (Tm) of 158.9° C., an intrinsic viscosity ([η]P) of 1.91 dL/g, a xylene-soluble content (CXS) at 20° C. of 0.9% by weight, and ethylene content of 0.6% by weight.

### (2) Production of Polypropylene-Based Copolymer (BCPP10)

### Polymerization of Component B

Polymerization was carried out in the same manner as in Example 1 except for using a gas prepared by adding 210 g of propylene, 210 g of ethylene and 40 g of 1-butene as a mixed gas in the polymerization of the component B, and changing the polymerization time to 0.8 hour. The polymerization conditions are shown in Table 1 and the analytical results of the resulting polymer are shown in Table 2.

### (3) Production of Film and its Physical Properties

Except that 279 g of BCPP10 was used as a polypropylene-based copolymer and 171 g of a propylene homopolymer having a [η] of 1.57 and a Tm of 163.5° C. was added, a polypropylene-based resin composition having an MFR of 3.0 (g/10 min) was obtained in the same manner as in Example 1.

The resulting polypropylene-based resin composition was extrusion processed in the same manner as in Example 1, thereby obtaining a film. The physical properties of the resulting film are shown in Table 4.

### Example 8

### (1) Production of Polypropylene-Based Copolymer (BCPP11)

Polymerization was carried out in the same manner as in Example 1 except for using 12.3 mg of the (a) component, using a gas prepared by adding 110 g of propylene and 220 g of ethylene and 150 g of 1-butene as a mixed gas in the polymerization of the component B, and changing the polymerization time to 0.4 hour. The polymerization conditions are shown in Table 1 and the analytical results of the resulting polymer are shown in Table 2.

Polymerization was carried out in the same manner as above, and the two polymers are used in following (2).

### (2) Production of Film and its Physical Properties

Except that 420 g of BCPP11 was used as a polypropylene-based copolymer and a propylene homopolymer was not added, the resulting polypropylene-based resin composition was extrusion processed in the same manner as in Example 1, thereby obtaining a film. The physical properties of the resulting film are shown in Table 4.

### Example 9

### (1) Production of Polypropylene-Based Copolymer (BCPP12)

Polymerization was carried out in the same manner as in Example 1 except for using 10.5 mg of the (a) component, using a gas prepared by adding 60 g of propylene and 200 g of ethylene and 260 g of 1-butene as a mixed gas in the polymerization of the component B, and changing the polymerization time to 0.4 hour. The polymerization conditions are shown in Table 1 and the analytical results of the resulting polymer are shown in Table 2.

Polymerization was carried out in the same manner as above, and the two polymers are used in following (2).

### (2) Production of Film and its Physical Properties

Except that 380 g of BCPP12 was used as a polypropylene-based copolymer and a propylene homopolymer was not added, the resulting polypropylene-based resin composition was extrusion processed in the same manner as in Example 1, thereby obtaining a film. The physical properties of the resulting film are shown in Table 4.

### Comparative Example 4

### (1) Production of Polypropylene-Based Copolymer (BCPP13)

Polymerization was carried out in the same manner as in Example 1 except for using 11.0 mg of the (a) component, using a gas prepared by adding 120 g of propylene and 250 g of ethylene and 80 g of 1-butene as a mixed gas in the polymerization of the component B, and changing the polymerization time to 0.3 hour. The polymerization conditions are shown in Table 1 and the analytical results of the resulting polymer are shown in Table 2.

Polymerization was carried out in the same manner as above, and the two polymers are used in following (2).

### (2) Production of Film and its Physical Properties

Except that 340 g of BCPP13 was used as a polypropylene-based copolymer and a propylene homopolymer was not added, the resulting polypropylene-based resin composition was extrusion processed in the same manner as in Example 1, thereby obtaining a film. The physical properties of the resulting film are shown in Table 4.

### Example 10

### (1) Production of Polypropylene-Based Copolymer (BCPP14)

### [Preparation of Solid Catalyst Component]

After displacing the SUS reaction container equipped with a stirrer having inner volume of 200 L with nitrogen, 80 L of hexane, 6.55 mole of titanium tetrabutoxide, 2.8 mole of diisobutyl phthalate, and 98.9 mole of tetraethoxysilane were added to make a homogeneous solution. Then, 51 L of diisobutyl ether solution of 2.1 mole/L of butylmagnesium chloride were added by dripping gradually over 5 hours, while maintaining the temperature inside the reaction container at 5° C. After the dripping finished, stirring was performed for an hour in room temperature and after the solid-liquid separation is performed in room temperature, washing with 70 L of toluene was performed three times. Then, after toluene was added so that slurry concentration is 0.2 kg/L, 47.6 mole of diisobutyl phthalate was added and reaction was performed at 95° C. for 30 minutes. After the reaction, solid-liquid separation was performed and washing with toluene was performed two times. Then, 3.13 mole of diisobutyl phthalate, 8.9 mole of butyl ether and 274 mole of titanium(IV) chloride were added and the reaction was performed at 105° C. for three hours. After the reaction, solid-liquid separation was performed at the same temperature and washing with 90 L of Toluene was performed two times at the same temperature. Then, after the slurry concentration is regulated to be 0.4 kg/L, 8.9 mole of butyl ether and 137 mole of titanium(IV) chloride were added, and the reaction was performed at 105° C. for an hour. After the reaction, solid-liquid separation was performed at the same temperature and washing with 90 L of toluene was performed six times at the same temperature and further washing was performed with 70 L of hexane three times, reduced-pressure drying was performed and 11.4 kg of solid catalyst component was obtained.

### [Preliminary Polymerization]

A preliminary polymerization was performed by sufficiently dehydrated and degassed 1.5 L of n-hexane, 30 mmol of triethylammonium, 3.0 mmol of Cyclohexylethyldimethoxysilane, and 16 g of the solid catalyst component above being added to SUS autoclave with 3 L of inner volume, 32 g of propylene being continuously supplied over 40 minutes while maintaining the temperature inside the autoclave at 3-10° C. Then the preliminary polymerization slurry was transferred to SUS autoclave equipped with a stirrer with 200 L of inner volume, 132 L of liquid butane was added and a slurry of preliminary polymerization catalyst component was obtained.

Polymerization of Component A

### [Polymerization Process (1)]

The vessel type reactor equipped with a stirrer having inner volume of 40 L was used. Propylene, hydrogen, triethylaluminum, cyclohexylethyldimethoxysilane, and slurry of preliminary polymerization catalyst component was continuously supplied, polymerization temperature was set at 78° C., stirring speed was set at 150 rpm, the fluid level of reactor was maintained at 18 L, the supply amount of propylene was set at 25 kg/hr, the supply amount of propylene was 19 NL/hr, the supply amount of triethylaluminum was set at 41 mmol/hr, the supply amount of cyclohexylethyldimethoxysilane was set at 6.15 mmol, the supply amount of preliminary polymerization catalyst component was set at 0.43 g/hr with a solid catalyst component conversion and the polymerization was performed for 0.27 hours. Polymers were discharged at 2.3 kg/hr.

### [Polymerization Process (2)]

The polymers discharged by polymerization process (1) was continuously transferred to a vessel-type reactor which was different from that in polymerization process (1), propylene and hydrogen was continuously supplied, polymerization temperature was set at 73° C., stirring speed was set at 150 rpm, the fluid level of reactor was set at 44 L, the amount of propylene to be supplied was set at 15 kg/hr, the amount of hydrogen to be supplied was set at 10 NL, and polymerization was continuously performed for 0.46 hours. The polymer was discharged at 3.4 kg/hr.

### [Polymerization Process (3)]

The polymers discharged by polymerization process (2) was continuously transferred to a vessel-type reactor which was different from those in polymerization processes (1) and (2), polymerization temperature was set at 68° C., stirring speed was set at 150 rpm, the fluid level of reactor was set at 44 L, and continuous polymerization was further performed for 0.50 hours. The polymer was discharged at 3.2 kg/hr.

### [Polymerization Process (4)]

The polymer discharged by polymerization process (3) was continuously transferred to a fluid bed reactor equipped with a stirrer having inner volume of 1 m³, propylene and hydrogen were continuously supplied, the polymerization temperature was set at 80° C., the polymerization pressure was set at 1.8 MPa, concentration ratio of propylene and hydrogen in the gas inside the reactor was set at 99.04% by volume/0.96% by volume (propylene concentration/hydrogen concentration) and the polymerization was performed for 3.1 hours. The polymer component A was discharged at 7.3 kg/hr. The intrinsic viscosity [η] of the obtained polymer component (component A) was 1.73 dL/g and Xylene-Soluble Content at 20° C. (CXS(A)) was 0.3% by weight.

Polymerization of Component B

### [Polymerization Process (5)]

Polymer component (component A) discharged by polymerization process (4) was continuously transferred to a fluid bed reactor equipped with a stirrer having an inner volume of 1 m³ which was different from that used in polymerization process (4), propylene, ethylene, 1-butene and hydrogen were continuously supplied, the polymerization temperature was set at 70° C., polymerization pressure was set at 1.4 MPa, concentration ratio of propylene, ethylene, 1-butene and hydrogen in the gas inside the reactor was set at 27.77% by volume/50% by volume/20.3% by volume/1.93% by volume propylene concentration/ethylene concentration/1-butene concentration/hydrogen concentration), oxygen as devitalizing agent was added in mole ratio of 0.006 against supplied triethylaluminum, and the polymerization was performed for 2.5 hours. The polymer component (component B) is discharged at 4.1 kg/hr. The intrinsic viscosity [η] of the obtained polymer component (component B) was 4.38 dL/g.

The analysis result of each component of polypropylene-based copolymer is shown in Table 2.

### (2) Production of Film and its Properties

Except that 400 g of BCPP14 was used as polypropylene-based copolymer, the amount of propylene homopolymer of [η]=1.57 and Tm=163.5° C. to be added was set at 100 g, and 0.02 weight of 2,5-dimethyl-2,5-di(tertiary butylperoxy)hexane was added, the production was performed in the same manner as in Example 1 and polypropylene-based resin composition of MFR=3.5 (g/10 min) was obtained.

The obtained polypropylene-based resin composition was processed in the same manner as in Example 1, thereby obtaining a film. The properties of the resulting film are shown in Table 4.

TABLE 1

| | | Polymerization | | | | | |
|---|---|---|---|---|---|---|---|
| | | Conditions of Component B | | | | | |
| Examples and | Use Amount of | Mixed Gas | | | | | Yield of |
| Comparative | (a) Component | Composition | | | Time | Pressure | Polypropylene-Based |
| Examples | mg | C4′ g | C3′ g | C2′ g | hr | MPa | Copolymer g |
| Example 1 | 11.7 | 80 | 210 | 190 | 1.2 | 0.8 | 260 |
| Example 2 | 13.0 | 40 | 240 | 190 | 1.0 | 0.8 | 317 |
| Example 3 | 9.4 | 150 | 200 | 170 | 1.0 | 0.8 | 207 |
| Example 4 | 11.1 | 30 | 250 | 190 | 1.1 | 0.8 | 230 |
| Example 5 | 9.2 | 20 | 260 | 190 | 0.9 | 0.8 | 200 |
| Example 6 | 11.1 | 80 | 170 | 220 | 0.7 | 0.8 | 253 |
| Comparative | 8.8 | — | 340 | 140 | 0.7 | 0.8 | 213 |
| Example 1 | | | | | | | |
| Comparative | 10.9 | 170 | 260 | 110 | 2.0 | 0.8 | 268 |
| Example 2 | | | | | | | |
| Comparative | 12.0 | 230 | 160 | 150 | 1.2 | 0.8 | 286 |
| Example 3 | | | | | | | |
| Example 7 | 12.9 | 40 | 210 | 210 | 0.8 | 0.8 | 357 |
| Example 8 | 12.3 | 150 | 110 | 220 | 0.4 | 0.8 | 221 |
| Example 9 | 10.5 | 260 | 60 | 200 | 0.4 | 0.8 | 176 |
| Comparative | 11.0 | 80 | 120 | 250 | 0.3 | 0.8 | 190 |
| Example 4 | | | | | | | |

TABLE 2

| | | Constitution of | | | | | | |
|---|---|---|---|---|---|---|---|---|
| | Ratio of | Component A | | | Constitution of Component B | | | |
| Examples and | Component B | | CXS | | Y | X | Z | |
| Comparative | (χ) | [η] | % by | Tm | % by | % by | % by | [η] |
| Examples | % by weight | dL/g | weight | ° C. | weight | weight | weight | dL/g |
| Example 1 | 37 | 1.77 | 0.6 | 163.8 | 59 | 33 | 8 | 4.24 |
| Example 2 | 36 | 1.84 | 0.5 | 164.0 | 56 | 40 | 4 | 3.96 |
| Example 3 | 28 | 1.78 | 0.6 | 163.2 | 65 | 19 | 16 | 4.29 |
| Example 4 | 36 | 1.72 | 0.6 | 162.9 | 60 | 37 | 3 | 4.14 |
| Example 5 | 38 | 1.65 | 0.6 | 162.6 | 54 | 45 | 1 | 3.59 |
| Example 6 | 30 | 1.84 | 0.6 | 163.5 | 67 | 26 | 7 | 4.49 |
| Comparative | 29 | 1.74 | 0.6 | 162.5 | 42 | 58 | — | 3.52 |
| Example 1 | | | | | | | | |
| Comparative | 33 | 1.72 | 0.6 | 163.7 | 41 | 39 | 20 | 3.72 |
| Example 2 | | | | | | | | |
| Comparative | 32 | 1.79 | 0.5 | 163.5 | 48 | 31 | 21 | 3.36 |
| Example 3 | | | | | | | | |
| Example 7 | 26 | 1.91 | 0.9 | 158.9 | 66 | 29 | 5 | 4.53 |
| Example 8 | 23 | 1.69 | 0.6 | 164.6 | 62 | 26 | 12 | 4.12 |
| Example 9 | 25 | 1.72 | 0.6 | 163.5 | 52 | 35 | 13 | 3.93 |
| Comparative | 17 | 1.79 | 0.6 | 163.9 | 77 | 14 | 9 | 4.61 |
| Example 4 | | | | | | | | |
| Example 10 | 20 | 1.73 | 0.3 | — | 62 | 32 | 6 | 4.38 |

TABLE 3

| | Structure of CXS of Polypropylene-Based Copolymer | | | | |
|---|---|---|---|---|---|
| Examples and | CXS (T) | Q | P | R | |
| Comparative | % by | % by | % by | % by | [η] |
| Examples | weight | weight | weight | weight | dL/g |
| Example 2 | 12.3 | 41 | 55 | 4 | 2.76 |
| Example 3 | 13.8 | 40 | 44 | 16 | 2.46 |
| Comparative | 12.4 | 32 | 68 | — | 2.33 |
| Example 1 | | | | | |
| Comparative | — | 27 | 53 | 20 | 2.53 |
| Example 2 | | | | | |

TABLE 4

| Examples and | | Melting | | Friction | | |
|---|---|---|---|---|---|---|
| Comparative | MFR | Point | Haze | Coefficient | | Impact |
| Examples | (g/10 min) | (° C.) | (%) | μs | μk | (kJ/m) |
| Example 1 | 4.1 | 163.9 | 57 | 0.79 | 0.83 | 6.0 |
| Example 2 | 3.8 | 162.9 | 59 | 0.76 | 0.80 | 9.2 |
| Example 3 | 3.8 | 163.8 | 57 | 0.87 | 0.85 | 9.8 |
| Example 4 | 3.8 | 163.1 | 62 | 0.82 | 0.81 | 8.6 |
| Example 5 | 4.6 | 163.6 | 56 | 0.88 | 0.80 | 7.2 |
| Example 6 | 3.5 | 163.6 | — | 0.86 | 0.83 | 5.9 |
| Comparative | 4.2 | 163.6 | 56 | 1.06 | 0.93 | 5.0 |
| Example 1 | | | | | | |
| Comparative | 4.4 | 163.4 | 28 | 1.01 | 1.02 | 0.9 |
| Example 2 | | | | | | |
| Comparative | 4.0 | 164.2 | — | 1.17 | 1.06 | 3.1 |
| Example 3 | | | | | | |
| Example 7 | 3.0 | 160.7 | — | 1.13 | 1.03 | 10.5 |
| Example 8 | 3.4 | 163.9 | — | 1.00 | 0.92 | 7.2 |
| Example 9 | 2.6 | 164.3 | — | 1.03 | 0.94 | 6.2 |
| Comparative | 2.7 | 164.0 | — | 1.20 | 0.99 | 4.1 |
| Example 4 | | | | | | |
| Example 10 | 3.5 | 164.2 | — | 0.83 | 0.83 | 4.5 |

The present invention may provide a polypropylene-based copolymer excellent in balance among heat resistance, transparency, sliding properties and low temperature impact resistance and a polypropylene-based resin composition containing the same, and such a copolymer and resin composition may be suitably used as a material of a film for packaging retort foods.

What is claimed is:

1. A polypropylene-based copolymer comprising 50 to 95% by weight of a polymer component (component A) mainly comprising the constitutional unit derived from propylene and having a melting point exceeding 155° C. and
5 to 50% by weight of a copolymer component (component B) of propylene, ethylene and an α-olefin having 4 or more carbon atoms in which the content (X) of the constitutional unit derived from propylene is 10≦X<50% by weight, the content (Y) of the constitutional unit derived from ethylene is 50<Y≦70% by weight, the content (Z) of the constitutional unit derived from an α-olefin having 4 or more carbon atoms is 0<Z≦20% by weight (provided that the total of X, Y and Z is 100% by weight), and the weight ratio of the content (Z) of the constitutional unit derived from an α-olefin having 4 or more carbon atoms to the content (X) of the constitutional unit derived from propylene is 1 or less.

2. The polypropylene-based copolymer according to claim 1, wherein the α-olefin having 4 or more carbon atoms is 1-butene.

3. A film comprising the polypropylene-based copolymer according to claim 1.

4. A polypropylene-based copolymer comprising a polymer component (component A) mainly comprising a constitutional unit derived from propylene and having a melting point exceeding 155° C. and a copolymer component (component B) of propylene, ethylene and an α-olefin having 4 or more carbon atoms, wherein;
(i) Xylene-Soluble Content at 20° C. (CXS) of the polypropylene-based copolymer is 4-40% by weight, and
(ii) the content (P) of the constitutional unit derived from propylene of the Soluble Content is 30≦P<70% by weight, the content (Q) of the constitutional unit derived from ethylene is 30<Q≦50% by weight, the content (R) of the constitutional unit derived from an α-olefin having 4 or more carbon atoms is 0<R≦20% by weight (provided that the total of P, Q and R is 100% by weight).
